(19) United States
(12) Patent Application Publication
(10) Pub. No.: US 2023/0238514 A1
(43) Pub. Date: Jul. 27, 2023

(54) SILICON-BASED CARBON COMPOSITE, PREPARATION METHOD THEREFOR, AND ANODE ACTIVE MATERIAL COMPRISING SAME

(71) Applicant: DAEJOO ELECTRONIC MATERIALS CO., LTD., Siheung-si, Gyeonggi-do (KR)

(72) Inventors: Junghyun LEE, Siheung-si, Gyeonggi-do (KR); Heonsoo PARK, Siheung-si, Gyeonggi-do (KR); Seul Gi LEE, Siheung-si, Gyeonggi-do (KR); Hyun Hee LIM, Siheung-si, Gyeonggi-do (KR); Jong Chan LIM, Siheung-si, Gyeonggi-do (KR)

(73) Assignee: DAEJOO ELECTRONIC MATERIALS CO., LTD., Siheung-si, Gyeonggi-do (KR)

(21) Appl. No.: 18/007,864

(22) PCT Filed: Jun. 2, 2020
(86) PCT No.: PCT/KR2020/007173

§ 371 Date: Dec. 2, 2022

(51) Int. Cl. H01M 4/36; H01M 4/38; H01M 4/48; H01M 4/58; H01M 4/587; C04B 35/14; C04B 35/626; C04B 35/628

(52) U.S. Cl. CPC H01M 4/366; H01M 4/386; H01M 4/483; H01M 4/5825; H01M 4/587; C04B 35/14; C04B 35/6261; C04B 35/62839; C04B 35/62894; C04B 35/62884; C04B 35/62886; C04B 35/62655; H01M 2004/027

(57) ABSTRACT

An embodiment of the present invention relates to a silicon-based carbon composite, a preparation method therefor, and an anode active material for a lithium secondary battery, comprising same, and, more specifically, the silicon-based carbon composite of the present invention is a silicon-based carbon composite having a core-shell structure, wherein the core comprises silicon, silicon oxide compound and magnesium silicate, the shell comprises at least two carbon layers comprising a first carbon layer and a second carbon layer, and the second carbon layer is reduced graphene oxide, and thus, during application of the silicon-based carbon composite to an anode active material for a secondary battery, the charge/discharge capacity, initial charge/discharge efficiency and capacity retention of the secondary battery can be improved.

### TECHNICAL FIELD

The present invention relates to a silicon-based-carbon composite, to a process for preparing the same, and to a negative electrode active material comprising the same for a lithium secondary battery.

### BACKGROUND ART

In recent years, as electronic devices become smaller, lighter, thinner, and more portable in tandem with the development of the information and communication industry, the demand for a high energy density of batteries used as power sources for these electronic devices is increasing. A lithium secondary battery is a battery that can best meet this demand, and research on small batteries using the same, as well as the application thereof to large electronic devices such as automobiles and power storage systems, is being actively conducted.

Carbon materials are widely used as a negative electrode active material for such a lithium secondary battery. Silicon-based negative electrode active materials are being studied in order to further enhance the capacity of batteries. Since the theoretical capacity of silicon (4,199 mAh/g) is greater than that of graphite (372 mAh/g) by 10 times or more, a significant enhancement in the battery capacity is expected.

The reaction scheme when lithium is intercalated into silicon is, for example, as follows:

22Li+5Si═Li₂₂Si₅ [Reaction Scheme 1]

In a silicon-based negative electrode active material according to the above reaction scheme, an alloy containing up to 4.4 lithium atoms per silicon atom with a high capacity is formed. However, in most silicon-based negative electrode active materials, volume expansion of up to 300% is induced by the intercalation of lithium, which destroys the negative electrode, making it difficult to exhibit high cycle characteristics.

In addition, this volume change may cause cracks on the surface of the negative electrode active material, and an ionic material may be formed inside the negative electrode active material, thereby causing the negative electrode active material to be electrically detached from the current collector. This electrical detachment phenomenon may significantly reduce the capacity retention rate of a battery.

In order to solve the above problems, Japanese Patent No. 5406799 discloses a method for preparing a silicon-silicon oxide composite containing magnesium or calcium by reacting carbon-coated silicon oxide powder with magnesium hydride (MgH₂) or calcium hydride (CaH₂) in order to reduce the irreversible reaction of silicon dioxide. In this method, the amount of oxygen is decreased during the reaction of a silicon oxide powder with MgH₂ or CaH₂. However, the silicon crystallite size rapidly grows due to a local exothermic reaction, and magnesium or calcium may be unevenly distributed, leading to a problem in that the specific capacity retention rate of silicon oxide is deteriorated.

Meanwhile, Japanese Patent No. 4393610 discloses a negative electrode active material in which silicon and carbon are mechanically processed to form a composite, and the surface of the silicon particles is coated with a carbon layer using a chemical vapor deposition (CVD) method.

In addition, Japanese Laid-open Patent Publication No. 2016-502253 discloses a negative electrode active material comprising porous silicon-based particles and carbon particles, wherein the carbon particles comprise fine carbon particles and coarse-grained carbon particles having different average particle diameters.

However, although these prior art references relate to a negative electrode active material comprising silicon and carbon, there is still a limit to suppressing volume expansion and contraction during charging and discharging and to enhancing the charge and discharge capacity and initial efficiency of a secondary battery at the same time.

### DISCLOSURE OF INVENTION

### Technical Problem

The present invention is devised to solve the problems of the prior art. A technical problem to be solved by the present invention is to provide a silicon-based-carbon composite capable of enhancing the charge and discharge capacity, initial charge and discharge efficiency, and capacity retention rate of a secondary battery.

Another technical problem to be solved by the present invention is to provide a process for preparing the silicon-based-carbon composite.

Still another technical problem to be solved by the present invention is to provide a negative electrode active material for a lithium secondary battery and a lithium secondary battery, each of which comprises the silicon-based-carbon composite.

### Solution to Problem

In order to accomplish the above object, an embodiment of the present invention provides a silicon-based-carbon composite having a core-shell structure, wherein the core comprises silicon, a silicon oxide compound, and magnesium silicate, and the shell comprises at least two carbon layers comprising a first carbon layer and a second carbon layer, wherein the second carbon layer is reduced graphene oxide.

Another embodiment of the present invention provides a process for preparing the silicon-based-carbon composite, which comprises obtaining a silicon-silicon composite oxide as a core; carrying out pulverization and classification such that the average particle diameter of the silicon-silicon composite oxide as a core is 3 μm to 15 μm to obtain a silicon-silicon composite oxide powder; forming a first carbon layer on the surface of the silicon-silicon composite oxide powder; and forming a second carbon layer on the surface of the first carbon layer to obtain a composite having a core-shell structure.

Still another embodiment of the present invention provides a process for preparing the silicon-based-carbon composite, which comprises obtaining a silicon-silicon composite oxide as a core; carrying out pulverization and classification such that the average particle diameter of the silicon-silicon composite oxide as a core is 3 μm to 15 μm to obtain a silicon-silicon composite oxide powder; forming a second carbon layer on the surface of the silicon-silicon composite oxide powder; and forming a first carbon layer on the surface of the second carbon layer to obtain a composite having a core-shell structure.

Still another embodiment provides a negative electrode active material, which comprises the silicon-based-carbon composite.

Still another embodiment provides a lithium secondary battery comprising the negative electrode active material.

### Advantageous Effects of Invention

The silicon-based-carbon composite according to an embodiment of the present invention has a core-shell structure. In particular, it is characterized in that the shell comprises at least two carbon layers comprising a first carbon layer and a second carbon layer and that the second carbon layer is reduced graphene oxide; thus, when it is applied as a negative electrode active material for a secondary battery, it is possible to enhance the charge and discharge capacity, initial charge and discharge efficiency, and capacity retention rate of the secondary battery at the same time.

### BRIEF DESCRIPTION OF DRAWING

Hereinafter, the present invention will be described in more detail with reference to the drawing.

FIG. 1 shows various schematic diagrams of a silicon-based-carbon composite comprising two carbon layers according to an embodiment of the present invention.

### BEST MODE FOR CARRYING OUT THE INVENTION

The present invention is not limited to what is disclosed below. Rather, it may be modified in various forms as long as the gist of the invention is not altered.

In the present specification, the term “comprising” is intended to indicate that a feature, number, step, operation, element, part, or combination thereof described in the specification is present. It should be understood not to exclude the possibility of addition or presence of one or more other features, numbers, steps, operations, elements, parts, or combinations thereof.

In addition, in the present specification, in the case where a part such as a layer or a film is mentioned to be formed “on” another element, it covers not only that one element is directly formed “on” another element, but also that other element(s) is interposed between them.

In addition, all numbers and expressions related to the quantities of components, reaction conditions, and the like used herein should be understood as it can be modified by the term “about,” unless otherwise indicated.

Silicon-Based-Carbon Composite

The silicon-based-carbon composite according to an embodiment of the present invention has a core-shell structure, wherein the core comprises silicon, a silicon oxide compound, and magnesium silicate, and the shell comprises at least two carbon layers comprising a first carbon layer and a second carbon layer, wherein the second carbon layer is reduced graphene oxide.

In the silicon-based-carbon composite according to an embodiment of the present invention, the shell comprises at least two carbon layers comprising a first carbon layer and a second carbon layer, and the second carbon layer is reduced graphene oxide; thus, when it is applied as a negative electrode active material for a secondary battery, it is possible to enhance the charge and discharge capacity, initial charge and discharge efficiency, and capacity retention rate of the secondary battery.

Hereinafter, the constitution of the silicon-based-carbon composite will be described in detail.

Core

The core of the silicon-based-carbon composite according to an embodiment of the present invention comprises silicon, a silicon oxide compound, and magnesium silicate.

Since silicon, a silicon oxide compound, and magnesium silicate are uniformly dispersed inside the core of the silicon-based-carbon composite and firmly bonded to form the core, it is possible to minimize the atomization of the core caused by a volume change during charging and discharging.

The content of silicon (Si) in the core may be 10% by weight to 90% by weight, 30% by weight to 80% by weight, or 40% by weight to 70% by weight, based on the total weight of the silicon-based-carbon composite. If the content of silicon is less than 10% by weight, the amount of an active material for occlusion and release of lithium is small, which may reduce the charge and discharge capacity of the lithium secondary battery. If the content of silicon exceeds 90% by weight, the charge and discharge capacity of the lithium secondary battery may be increased, whereas the contraction and expansion of the electrode during charging and discharging may be excessively increased, and the negative electrode active material powder may be further atomized, which may deteriorate the cycle characteristics.

Meanwhile, the content of magnesium (Mg) in the silicon-based-carbon composite may be 0.2% by weight to 15% by weight, 0.2% by weight to 10% by weight, or 0.2% by weight to 8% by weight, based on the total weight of the silicon-based-carbon composite.

If the content of magnesium (Mg) in the silicon-based-carbon composite is 0.2% by weight or more, the initial efficiency of the secondary battery may be enhanced. If the content of magnesium is 15% by weight or less, it is advantageous in terms of the cycle characteristics and handling stability of the secondary battery. In addition, as the content of magnesium increases, the Mg₂SiO₄ phase increases, which increases the crystallite size of the magnesium silicate, so that the initial efficiency may be increased to 85% or more. However, if the initial efficiency is excessively increased, there may be a problem in that the cycle characteristics may be deteriorated; thus, it is important to control the content of magnesium (Mg) within a specific range.

Meanwhile, according to an embodiment of the present invention, the silicon-based-carbon composite may comprise a metal other than magnesium. The other metals may be at least one selected from the group consisting of alkali metals, alkaline earth metals, Groups 13 to 16 elements, transition metals, rare earth elements, and combinations thereof. Specific examples thereof may include Li, Ca, Sr, Ba, Y, Ti, Zr, Hf, V, Nb, Cr, Mo, W, Fe, Pb, Ru, Ir, Pd, Pt, Cu, Ag, Au, Zn, Cd, B, Al, Ga, Sn, In, Ge, P, As, Sb, Bi, S, and Se.

In the silicon-based-carbon composite, the core comprises silicon, a silicon oxide compound, and magnesium silicate, and they are dispersed with each other so that the phase interfaces are in a bonded state, that is, each phase is in a bonded state at the atomic level. Thus, the volume change is small when lithium ions are occluded and released, and cracks do not occur in the negative electrode active material even when charging and discharging are repeated. Accordingly, since there is no steep decrease in the capacity with respect to the number of cycles, the cycle characteristics of the secondary battery may be excellent.

In addition, since each phase of the silicon, silicon oxide compound, and magnesium silicate is in a bonded state at the atomic level, the detachment of lithium ions is facilitated during discharging of the secondary battery, which makes a good balance between the charge amount and the discharge amount of lithium ions and increases the charge and discharge efficiency. Here, the charge and discharge efficiency (%) refers to a ratio (y/x×100) of the discharge capacity (y) to the charge capacity (x), indicating a ratio of lithium ions that can be released during discharging among the lithium ions occluded in the negative electrode active material during charging.

The core of the silicon-based-carbon composite may have an average particle diameter (D₅₀) of 2 μm to 15 μm, specifically, 2 μm to 10 μm or 3 μm to 9 μm. If the average particle diameter (D₅₀) of the core is less than 2 μm, the bulk density is too small, and the charge and discharge capacity per unit volume may be deteriorated. On the other hand, if the average particle diameter (D₅₀) exceeds 15 μm, it is difficult to prepare an electrode layer, so that it may be peeled off from the current collector.

In addition, according to an embodiment, a core structure may be formed in which closed pores or voids are introduced to the inside of the core, and silicon, a silicon oxide compound, and magnesium silicate are simultaneously employed and uniformly dispersed in the atomic order. In addition, the size of each particle of the silicon, silicon oxide compound, and magnesium silicate in the core may be atomized. If the size of each particle of the silicon, silicon oxide compound, and magnesium silicate is too large, it would be difficult to be present inside the core, and the function as a core cannot be sufficiently performed.

As the silicon-based-carbon composite comprises the core having the above components, it is possible to suppress volume expansion, and it produces the effect of preventing or reducing a side reaction with an electrolyte. As a result, the discharge capacity, lifespan characteristics, and thermal stability of the secondary battery may be enhanced.

Hereinafter, each component contained in the core will be described in detail.

Silicon

As the core in the silicon-based-carbon composite comprises silicon, a high capacity may be achieved when it is applied to a secondary battery.

Silicon may be formed as dispersed in a silicon oxide compound or magnesium silicate.

Since silicon charges lithium, the capacity of a secondary battery may decrease if silicon is not employed. The silicon may be crystalline or amorphous and specifically may be amorphous or in a similar phase thereto. If the silicon is crystalline, as the size of the crystallites is small, the density of the matrix may be enhanced and the strength may be fortified to prevent cracks. Thus, the initial efficiency or cycle lifespan characteristics of the secondary battery can be further enhanced. In addition, if the silicon is amorphous or in a similar phase thereto, expansion or contraction during charging and discharging of the lithium secondary battery is small, and battery performance such as capacity characteristics can be further enhanced.

Although the silicon has high initial efficiency and battery capacity together, it is accompanied by a very complex crystal change by electrochemically absorbing, storing, and releasing lithium atoms. As the reaction of electrochemically absorbing, storing, and releasing lithium atoms proceeds, the composition and crystal structure of silicon may be changed to Si (crystal structure: Fd3m), LiSi (crystal structure: 141/a), Li₂Si (crystal structure: C2/m), Li₇Si₂ (Pbam), Li₂₂Si₁₅ (F23), or the like. In addition, the volume of silicon may expand by about 4 times (400%) according to the change in the complex crystal structure. Thus, as the charge and discharge cycle is repeated, silicon is destroyed, and a bond between lithium atoms and silicon is formed. As a result, the intercalation site of lithium atoms that silicon had in the beginning is damaged, which significantly reduces the cycle lifespan.

The silicon may be uniformly distributed inside the silicon-based-carbon composite. In such a case, excellent mechanical properties such as strength may be achieved.

In addition, the silicon-based-carbon composite may have a structure in which silicon is uniformly dispersed in a silicon oxide compound or magnesium silicate. In addition, as the silicon is dispersed in magnesium silicate to surround it, it is possible to suppress the expansion and contraction of silicon to obtain high performance of the secondary battery.

In the silicon-based-carbon composite according to an embodiment of the present invention, when the silicon is subjected to an X-ray diffraction (Cu-Kα) analysis using copper as a cathode target and calculated by the Scherrer equation based on a full width at half maximum (FWHM) of the diffraction peak of Si(220) around 2θ=47.5°, it may have a crystallite size of 2 nm to 20 nm, 2 nm to 15 nm, or 2 nm to 8 nm.

In addition, the silicon contained in the silicon-based-carbon composite may be in an amorphous form, a crystalline form having a crystallite size of 2 nm to 20 nm, or a mixture thereof. Although it is preferable that silicon is close to 100% amorphous, it is difficult to obtain completely amorphous silicon in the process; thus, the silicon may be a mixture of amorphous and crystalline forms. Even in such a case, the ratio of the amorphous form of silicon is preferably 50% or more. If the silicon is amorphous, crystalline with a crystallite size in the above range, or a mixture thereof, cracking may be suppressed during the first charging and discharging of the secondary battery. If some cracks are generated during the first charging and discharging, these cracks become a starting point and expand to lead to large cracks during repeated charging and discharging. Thus, if the silicon is outside the above range, a problem may arise in the performance of the secondary battery. In addition, if the silicon is amorphous or crystalline with a crystallite size in the above range, damage due to the volume expansion by repeated charging and discharging can be mitigated.

If the crystallite size of the silicon is less than 2 nm, the charging and discharge capacity of the secondary battery may be reduced, and the properties of the material may change during storage due to increased reactivity, which may cause problems in the process.

In addition, if the crystallite size of the silicon is 2 nm or more, there is little concern that the charge and discharge capacity will be reduced. If the crystallite size of the silicon is 20 nm or less, there is a low possibility that a region that does not contribute to discharging is generated; thus, it is possible to suppress a reduction in the Coulombic efficiency representing the ratio of charge capacity to discharge capacity.

In addition, when the silicon is fine particles, it preferably forms a lithium alloy having a large specific surface area to thereby suppress the destruction of the bulk. The silicon fine particles react with lithium during charging to form Li_{4.2}Si and return to silicon during discharging. In such an event, when X-ray diffraction is frequently performed on the silicon fine particles, the silicon shows a broad pattern, and its structure may be changed to amorphous silicon.

If the silicon is further atomized to an amorphous state or a crystallite size of about 2 nm to 6 nm, the density of the matrix may be enhanced and the strength may be fortified to prevent cracks. Thus, the initial efficiency or cycle lifespan characteristics of the secondary battery can be further enhanced.

Silicon Oxide Compound

As the core of the silicon-based-carbon composite comprises a silicon oxide compound, it is possible to enhance the capacity and to reduce volume expansion when applied to a secondary battery.

The silicon oxide compound may be a silicon-based oxide represented by the formula SiOₓ (0.5≤x≤1.5). The silicon oxide compound may be specifically SiOₓ (0.8≤x≤1.2), more specifically SiOₓ (0.9<x≤1.1). In the formula SiOₓ, if the value of x is less than 0.5, expansion and contraction may be increased and lifespan characteristics may be deteriorated during charging and discharging of the secondary battery. In addition, if x exceeds 1.5, there may be a problem in that the initial efficiency of the secondary battery is decreased as the amount of inactive oxides increases.

The silicon oxide compound can be obtained by a method comprising mixing and heating a silicon powder and a silicon dioxide powder; and cooling and precipitating a silicon oxide gas produced thereby. Although the silicon oxide compound may be partially or completely removed during an etching step, it may be formed again during the manufacturing process by surface oxidation of the silicon particles.

The silicon oxide compound may be employed in an amount of 0.1% by weight to 45% by weight based on the total weight of the silicon-based-carbon composite.

If the content of the silicon oxide compound is less than 0.1% by weight, the volume expansion and lifespan characteristics of the secondary battery may be deteriorated. If it exceeds 45% by weight, the initial irreversible reaction of the secondary battery may increase.

Magnesium Silicate

As the core of the silicon-based-carbon composite comprises magnesium silicate, charge and discharge capacity characteristics and cycle characteristics may be enhanced when it is applied to a secondary battery.

Since magnesium silicate hardly reacts with lithium ions during charging and discharging of a secondary battery, it is possible to reduce the expansion and contraction of the electrode when lithium ions are occluded in the electrode, thereby enhancing the cycle characteristics of the secondary battery. In addition, the strength of the matrix, which is a continuous phase surrounding the silicon, can be fortified by the magnesium silicate.

The magnesium silicate may be represented by the following Formula 1:

MgₓSiO_{y} [Formula 1]

in Formula 1, 0.5≤x≤2, and 2.5≤y≤4.

The magnesium silicate may comprise at least one selected from MgSiO₃ crystals (enstatite) and Mg₂SiO₄ crystals (forsterite).

In addition, according to an embodiment, the magnesium silicate may comprise MgSiO₃ crystals and may further comprise Mg₂SiO₄ crystals.

In addition, the magnesium silicate may comprise substantially a large amount of MgSiO₃ crystals in order to enhance the charge and discharge capacity and initial efficiency.

In the present specification, the phrase “comprising substantially a large amount of” a component may mean to comprise the component as a main component or mainly comprise the component.

In the magnesium silicate, the content of magnesium relative to SiOₓ may have an impact on the initial discharge characteristics or cycle characteristics during charging and discharging. Silicon in the SiOₓ may be alloyed with lithium atoms to enhance the initial discharge characteristics. Specifically, if Mg₂SiO₃ crystals are employed in the magnesium silicate in a substantially large amount, the improvement effect of the cycle during charging and discharging may be increased.

If the magnesium silicate comprises both Mg₂SiO₃ crystals and Mg₂SiO₄ crystals, the initial efficiency may be enhanced. If Mg₂SiO₄ crystals are employed more than Mg₂SiO₃ crystals, the degree of alloying of silicon with lithium atoms is lowered, whereby the initial discharge characteristics may be deteriorated.

In addition, when the magnesium silicate comprises MgSiO₃ crystals and Mg₂SiO₄ crystals together, it is preferable that the MgSiO₃ crystals and Mg₂SiO₄ crystals are uniformly dispersed in the core. Their crystallite size may be 20 nm or less, specifically, 10 nm to 20 nm or 5 nm to 10 nm.

According to an embodiment of the present invention, if the silicon-based-carbon composite comprises MgSiO₃ crystals and Mg₂SiO₄ crystals together, the initial efficiency may be further enhanced.

If the silicon-based-carbon composite comprises MgSiO₃ crystals, the MgSiO₃ crystals (e.g., a specific gravity of 2.7 g/cm³) have a smaller change in volume based on the change of volume of silicon (e.g., a specific gravity of 2.33 g/cm³), as compared with Mg₂SiO₄ crystals (e.g., a specific gravity of 3.2 g/cm³); thus, the cycle characteristics of a secondary battery can be further enhanced. In addition, the MgSiO₃ crystals and Mg₂SiO₄ crystals may act as a diluent or inert material in a negative electrode active material. In addition, if MgSiO₃ crystals are formed, the atomization caused by the contraction and expansion of silicon is suppressed, whereby the initial efficiency can be enhanced.

In addition, the magnesium silicate hardly reacts with lithium ions; thus, when it is contained in an electrode, it is possible to reduce the contraction and expansion of the electrode when lithium ions are occluded and to enhance the cycle characteristics.

In addition, the strength of the matrix, which is a continuous phase surrounding the silicon, can be fortified by magnesium silicate.

In addition, as the doping amount of magnesium increases, a large amount of Mg₂SiO₄ may be formed, whereas the crystallite size of silicon may be also increased. It is understood that since the molar ratio of magnesium to silicon is large, the amount of evaporation of magnesium increases and the reaction temperature rises accordingly, thereby increasing the crystallite size of silicon. As the crystallite size is increased, the amount of silicon supposed to be alloyed with lithium atoms is small, so that the initial efficiency of the secondary battery may be deteriorated. Thus, it may be undesirable that Mg₂SiO₄ is formed in excess. At the same time, since the silicon atoms and the magnesium atoms react to form Mg₂SiO₄, which hardly reacts with lithium atoms, the initial efficiency of the secondary battery may be deteriorated.

In addition, according to an embodiment, the magnesium silicate comprises MgSiO₃ crystals and further comprises Mg₂SiO₄ crystals. In such an event, in an X-ray diffraction analysis, the ratio IF/IE of an intensity (IF) of the X-ray diffraction peak corresponding to Mg₂SiO₄ crystals appearing in the range of 2θ=22.3° to 23.3° to an intensity (IE) of the X-ray diffraction peak corresponding to MgSiO₃ crystals appearing in the range of 2θ=30.5° to 31.5° may be greater than 0 to 1, specifically, 0.1 to 1.

When the IF/IE satisfies the above range, the ratio of magnesium to silicon may decrease, so that a temperature increase due to evaporation of magnesium may be reduced. As a result, the growth of silicon may be suppressed, so that the crystallite size may be 10 nm or less, which may enhance the cycle characteristics and initial efficiency of the secondary battery.

As the core of the silicon-based-carbon composite comprises magnesium silicate, even when lithium ions rapidly increase during charging and discharging, it hardly reacts with lithium ions, so that it produces the effect of reducing the degree of expansion and contraction of the electrode. As a result, the cycle characteristics of the secondary battery may be enhanced, and the irreversible capacity is small, whereby the charging and discharging efficiency may be enhanced.

Shell

The silicon-based-carbon composite according to an embodiment of the present invention comprises a shell comprising a carbon layer (carbon film) on the surface of the core. In particular, the shell comprises at least two carbon layers comprising a first carbon layer and a second carbon layer, wherein the second carbon layer is reduced graphene oxide.

According to an embodiment of the present invention, as the shell comprises at least two carbon layers on the surface of the core, the strength may be fortified, excellent electrical conductivity may be secured even after the electrode expands during charging and discharging, and side reactions with the electrolyte are suppressed, so that it is possible to enhance the charge and discharge capacity, initial charge and discharge efficiency, and capacity retention rate of the secondary battery.

Specifically, if the shell is composed of at least two carbon layers, even if cracks occur on the surface of one of the carbon layers, it is possible to maintain the state in which the carbon layers are electrically connected until the other carbon layer without cracks is completely detached.

In addition, the shell has a structure that surrounds the core, wherein at least two carbon layers adopted therein, that is, the first carbon layer and the second carbon layer, may produce an effect as a buffer layer (cushioning layer).

The buffer layer is effective as a mechanical buffer support surrounding the core. More specifically, the buffer layer may suppress the deterioration, cracking, and volume expansion of the core caused by the mechanical expansion of silicon during charging and discharging.

In particular, when the second carbon layer is reduced graphene oxide, it is possible to produce the effect as a barrier layer or a buffer layer against cracking.

According to an embodiment of the present invention, in the silicon-based-carbon composite, a first carbon layer (CVD coating) and a second carbon layer (reduced graphene coating) may be sequentially disposed on the core. In such an event, in the first carbon layer, a carbon layer is mainly formed in the pores in the core, and the CVD coating is uniformly formed in the internal pores, which can prevent the formation of large silicon particles caused by sintering of nanosilicon by the volume expansion of silicon during charging and discharging. In the second carbon layer, reduced graphene with good conductivity is coated, which makes it possible to adjust the content of carbon depending on the purposes, resulting in the advantages of low specific surface area, high conductivity, high capacity, and long lifespan.

In addition, as a negative electrode material in which at least two types of carbon layers are sequentially laminated, respectively, on the entire, most, or part of the surface of the core is used, it is possible to suppress the release of lithium from the core and to suppress the volume change of silicon particles that takes place during intercalation and detachment of lithium, thereby maintaining high conductivity between negative electrode material particles and conduction paths. As a result, it is possible to provide a negative electrode material for a lithium secondary battery having high charge and discharge capacity and excellent cycle life characteristics and a lithium secondary battery using the same. Since the second carbon layer is formed of reduced graphene oxide (RGO) with particularly high electrical conductivity, it is possible to enhance the intercalation and detachment characteristics of lithium by lowering the contact resistance between the active material layer, current collector, and active material particles. The first carbon layer may comprise at least one selected from the group consisting of amorphous carbon, crystalline carbon, carbon nanofibers, chemical vapor graphene, and carbon nanotubes. If the amorphous carbon is disposed on the core, the strength of the first carbon layer is properly maintained, so that expansion of the core can be suppressed.

According to another embodiment of the present invention, in the silicon-based-carbon composite, a second carbon layer (oxidized/reduced graphene coating) and a first carbon layer (CVD coating) may be sequentially disposed on the core. In such an event, it is possible to reduce the size of silicon crystallites, which have the most impact on electrode lifespan, through low-temperature carbon coating; and to control the amount of carbon coating, resulting in the advantages of high capacity, low specific surface area, and high conductivity. In addition, when the first carbon layer comprises crystalline carbon, it is preferably possible to further enhance the conductivity of the negative electrode active material.

In addition, the at least two carbon layers for forming the shell may be laminated in various ways, as long as the desired effects of the present invention are not impaired. Up to 6 layers may be laminated. Specifically, the number of layers laminated for the shell may be 2 to 6. Specifically, the number of layers laminated for the shell may be 2 to 4 or 2 to 3.

When the silicon-based-carbon composite according to an embodiment of the present invention is applied as a negative electrode active material of a lithium secondary battery, the shell comprising the at least two carbon layers can play a very important role as a reaction barrier layer in the reaction between lithium and silicon in the core.

Specifically, the shell allows lithium to pass through, but prevents oxygen from passing through. It can prevent oxygen from reacting with silicon, a silicon oxide compound, or magnesium silicate in the core. In addition, if the shell is uniformly coated to be formed on the core, there is an effect of suppressing cracking caused by stress caused by the rapid volume expansion of silicon. Since cracks are formed irregularly and discontinuously, there is a possibility that the electrolyte does not come into contact with the inside of the negative electrode active material or that a portion that is electrically blocked may be present, which causes a defect in the secondary battery. In this regard, the role of the reduced graphene oxide of the second carbon layer is of significance. Since the reduced graphene oxide has high electrical conductivity, it is possible to maintain a state in which the carbon layers are electrically connected.

Meanwhile, the total content of carbon (C) in the first carbon layer and the second carbon layer may be 5% by weight to 50% by weight based on the total weight of the silicon-based-carbon composite. In addition, the total content of carbon (C) in the first carbon layer and the second carbon layer may be 10% by weight to 40% by weight, 5% by weight to 30% by weight, or 5% by weight to 20% by weight, based on the total weight of the silicon-based-carbon composite.

If the total content of carbon (C) in the first carbon layer and the second carbon layer is less than 5% by weight, there may be a problem in that the effect of suppressing volume expansion and enhancing the conductivity of the negative electrode active material is insignificant. In addition, if the total content of carbon (C) in the first carbon layer and the second carbon layer exceeds 50% by weight, there may be a problem in that a thick carbon layer is formed by the excess carbon content, which may deteriorate the initial efficiency and capacity due to irreversibility, and that detachment of lithium ions is difficult.

The content of carbon (C) in the second carbon layer may preferably be 3% by weight to 20% by weight, more preferably, 3% by weight to 15% by weight, even more preferably, 3% by weight to 10% by weight, based on the total weight of the silicon-based-carbon composite.

The total thickness of the first carbon layer and the second carbon layer may be 10 nm to 1,200 nm, 10 nm to 90 nm, or 10 nm to 50 nm. If the total thickness of the first carbon layer and the second carbon layer satisfies the above range, even if the volume of the core is changed due to the intercalation and detachment of lithium, it is possible to effectively prevent or alleviate the atomization of the core and to effectively prevent or alleviate side reactions between silicon and electrolyte, thereby enhancing the performance of the secondary battery.

If the total content of carbon (C) in the first carbon layer and the second carbon layer or the total thickness thereof satisfies the above range, it is possible to maintain conductive paths between the respective carbon layers, thereby suppressing the surface oxidation of the core and to enhance the electrical conductivity of the secondary battery, thereby enhancing the capacity characteristics and cycle characteristics of the secondary battery. If the total content of carbon (C) in the first carbon layer and the second carbon layer or the total thickness thereof does not satisfy the above range, the initial efficiency of the secondary battery may be excessively deteriorated.

In the silicon-based-carbon composite according to an embodiment of the present invention, it is preferable that the carbon film comprising at least two carbon layers is formed such that each carbon layer is formed thinly and uniformly along the entire outer shape of the shell while the outer shape of the shell is maintained. It may be in the form in which some or most thereof covers the entire surface of the core. If each carbon layer is formed thinly and uniformly on the surface of the core, the electrical contact between the particles contained in the negative electrode active material can be enhanced.

First Carbon Layer

The first carbon layer according to an embodiment of the present invention may comprise at least one selected from the group consisting of amorphous carbon, crystalline carbon, carbon nanofibers, reduced graphene oxide, and carbon nanotubes. Specifically, the first carbon layer may comprise at least one selected from the group consisting of amorphous carbon and crystalline carbon.

For example, the first carbon layer may comprise reduced graphene oxide, and the second carbon layer may comprise chemical vapor graphene. In addition, the first carbon layer and the second carbon layer may comprise the above interchangeably.

If the first carbon layer comprises amorphous carbon, the strength of the first carbon layer is properly maintained, so that expansion of the core can be suppressed.

The amorphous carbon may be at least one selected from the group consisting of soft carbon (low-temperature calcined carbon), hard carbon, pitch carbide, mesophase pitch carbide, carbon-based polymer resin, and calcined coke.

The raw material of pitch may be, for example, petroleum-based, coal-based, or a mixture thereof. For example, it may be coal tar pitch, petroleum pitch, organic synthetic pitch obtainable by polycondensation of condensed polycyclic aromatic hydrocarbon compounds, or organic synthetic pitch obtainable by polycondensation of heteroatom-containing condensed polycyclic aromatic hydrocarbon compounds. Specifically, the raw material of pitch may be coal tar pitch.

If a first carbon layer is formed using pitch, the conductivity of a negative electrode active material may be enhanced through a simple thermal treatment process by thermally treating and carbonizing the pitch raw material.

In addition, when the first carbon layer comprises crystalline carbon, the conductivity of the negative electrode active material may be improved.

The crystalline carbon may be at least one selected from the group consisting of plate-shaped, spherical, and fibrous natural graphite and fibrous artificial graphite.

In addition, the content of carbon (C) in the first carbon layer may be 2% by weight to 30% by weight based on the total weight of the silicon-based-carbon composite. Specifically, the content of carbon (C) in the first carbon layer may be 3% by weight to 30% by weight, 3% by weight to 20% by weight, or 5% by weight to 10% by weight.

If the content of carbon (C) in the first carbon layer is less than 2% by weight, there may be a problem in that the effect of suppressing volume expansion and enhancing the conductivity of the negative electrode active material is insignificant. In addition, if the content of carbon (C) in the first carbon layer exceeds 30% by weight, there may be a problem in that the capacity of a secondary battery may decrease and that lithium ions may hardly be detached.

In addition, the thickness of the first carbon layer may be 2 nm to 400 nm, 2 nm to 200 nm, or 5 nm to 100 nm. If the thickness of the first carbon layer satisfies the above range, even if the volume of the core is changed due to the intercalation and detachment of lithium, it is possible to effectively prevent or alleviate the atomization of the core and to effectively prevent or alleviate side reactions between silicon and electrolyte.

On the other hand, if the thickness of the first carbon layer is less than 2 nm, the electrical conductivity of the first carbon layer is too low; thus, when it is applied to a negative electrode active material, there may be a problem in that the reactivity with the electrolyte is increased and the initial efficiency is deteriorated. Further, the effect of suppressing volume expansion of the silicon particles and capacity enhancement may be insignificant, and a uniform coating may not be obtained. In addition, if the thickness of the first carbon layer exceeds 400 nm, the mobility of lithium ions may be hindered, which increases resistance, and the adhesive strength to the core may be deteriorated.

According to an embodiment of the present invention, the first carbon layer may further comprise graphite.

Second Carbon Layer

The second carbon layer according to an embodiment of the present invention may be reduced graphene oxide having particularly high electrical conductivity. If reduced graphene oxide is formed in the second carbon layer, since a reduced graphene oxide film has high mechanical strength, it is possible to effectively suppress or alleviate cracking caused by volume expansion during charging and discharging of silicon in the core and to provide a negative electrode active material and a secondary battery having excellent lifespan characteristics. In addition, if the second carbon layer is reduced graphene oxide, the contact resistance between the negative electrode active material layer and the current collector and between the negative electrode active material particles is reduced, thereby producing the effect that the intercalation and detachment characteristics of lithium are enhanced.

The reduced graphene oxide in the second carbon layer may be formed by partially or substantially completely reducing graphene oxide.

The reduced graphene oxide in the second carbon layer may have a specific surface area (Brunauer-Emmett-Teller; BET) of 5 m²/g to 30 m²/g, 5 m²/g to 20 m²/g, or 5 m²/g to 10 m²/g.

A negative electrode active material coated with reduced graphene oxide of the second carbon layer may have an electrical conductivity of 100 S/cm to 3,000 S/cm, 500 S/cm to 3,000 S/cm, or 1,000 S/cm to 3,000 S/cm.

Electrical conductivity in a negative electrode active material is an important factor for facilitating the movement of electrons during an electrochemical reaction. However, when a high-capacity negative electrode active material is prepared using silicon, the electrical conductivity may not reach an appropriate value. As the shell comprises a second carbon layer comprising reduced graphene oxide that has an electrical conductivity satisfying the above range, there is an effect of enhancing the electrical conductivity between the shell of carbon layers and the core, and the lifespan characteristics of a secondary battery can be further improved.

The reduced graphene oxide of the second carbon layer may have I_{1,360}/I_{1,580} of 0.1 to 2, 0.2 to 1.5, or 0.4 to 1.5, which is an integrated intensity ratio for absorption bands of 1,360 cm⁻¹ and 1,580 cm⁻¹.

In addition, the content of carbon (C) in the second carbon layer may be 3% by weight to 20% by weight based on the total weight of the silicon-based-carbon composite. Specifically, the content of carbon (C) in the second carbon layer may be 3% by weight to 15% by weight, 3% by weight to 10% by weight, or 3% by weight to 5% by weight.

If the content of carbon (C) in the second carbon layer is less than 3% by weight, there may be a problem in that the effect of suppressing volume expansion and enhancing the conductivity of the negative electrode active material is insignificant. In addition, if the content of carbon (C) in the second carbon layer exceeds 20% by weight, there may be a problem in that the capacity of the secondary battery may decrease and that lithium ions may hardly be detached.

In addition, the thickness of the second carbon layer may be 20 nm to 1 μm, 20 nm to 500 nm, or 20 nm to 100 nm. If the thickness of the second carbon layer satisfies the above range, even if the volume of the core is changed due to the intercalation and detachment of lithium, it is possible to effectively prevent or alleviate the atomization of the core and to effectively prevent or alleviate side reactions between silicon and electrolyte.

On the other hand, if the thickness of the second carbon layer is less than 20 nm, the electrical conductivity of the second carbon layer is too low; thus, when it is applied to a negative electrode active material, there may be a problem in that the reactivity with the electrolyte is increased and the initial efficiency is deteriorated. In addition, the effect of suppressing volume expansion and enhancing the capacity of silicon particles may be insignificant, and a uniform coating may not be obtained. If the thickness of the second carbon layer exceeds 1 μm, the thickness of the second carbon layer is too thick, thereby hindering the mobility of lithium ions, which increases resistance, and the adhesive strength to the core may be deteriorated.

Meanwhile, the content of oxygen (O) in the reduced graphene oxide in the second carbon layer may be 0.01% by weight to 20% by weight based on the total weight of the reduced graphene oxide. Specifically, the content of oxygen (O) in the reduced graphene oxide in the second carbon layer may be 3% by weight to 15% by weight or 3% by weight to 10% by weight. If the content of oxygen (O) in the reduced graphene oxide in the second carbon layer satisfies the above range, the reduction degree of graphene oxide is high, in which case the reduced graphene may have high conductivity.

When the silicon-based-carbon composite is applied to a negative electrode, the electrode expansion rate of the silicon-based-carbon composite may be 60% to 150%, 60% to 100%, or 60% to 80%, based on the thickness of the electrode after one charge.

The reduced graphene oxide in the second carbon layer may comprise at least one selected from the group consisting of lithium (Li), sodium (Na), and potassium (K) in an amount of 0.02% by weight to 5% by weight based on the total weight of carbon (C) in the second carbon layer.

According to an embodiment of the present invention, the second carbon layer may further comprise graphite.

Process for Preparing a Silicon-Based-Carbon Composite

The present invention may provide a process for preparing the silicon-based-carbon composite.

The process for preparing a silicon-based-carbon composite according to an embodiment of the present invention may comprise obtaining a silicon-silicon composite oxide as a core; carrying out pulverization and classification such that the average particle diameter of the silicon-silicon composite oxide as a core is 3 μm to 15 μm to obtain a silicon-silicon composite oxide powder; forming a first carbon layer on the surface of the silicon-silicon composite oxide powder; and forming a second carbon layer on the surface of the first carbon layer to obtain a composite having a core-shell structure.

The process for preparing a silicon-based-carbon composite according to another embodiment of the present invention may comprise obtaining a silicon-silicon composite oxide as a core; carrying out pulverization and classification such that the average particle diameter of the silicon-silicon composite oxide as a core is 3 μm to 15 μm to obtain a silicon-silicon composite oxide powder; forming a second carbon layer on the surface of the silicon-silicon composite oxide powder; and forming a first carbon layer on the surface of the second carbon layer to obtain a composite having a core-shell structure.

Specifically, the process for preparing a silicon-based-carbon composite may comprise (1) preparing a mixture obtained by using a silicon powder and a silicon dioxide powder; (2) heating and evaporating the mixture and metallic magnesium at different temperatures and depositing and cooling them to obtain a silicon-silicon composite oxide; (3) thermally treating the silicon-silicon composite oxide to obtain a thermally treated silicon-silicon composite oxide as a core; (4) carrying out pulverization and classification such that the average particle diameter of the thermally treated silicon-silicon composite oxide as a core is 3 μm to 15 μm to obtain a silicon-silicon composite oxide powder; (5) forming a first carbon layer on the surface of the silicon-silicon composite oxide powder; and (6) forming a second carbon layer on the surface of the first carbon layer to obtain a composite having a core-shell structure.

Specifically, in the process for preparing a silicon-based-carbon composite according to an embodiment of the present invention, step (1) may comprise preparing a mixture obtained by using a silicon powder and a silicon dioxide powder.

The mixture may be obtained by heating a mixture obtained by mixing a silicon powder and a silicon dioxide powder to a temperature of 1,200° C. to 1,600° C. in an inert gas atmosphere or vacuum and depositing and precipitating the resulting gas.

The mixture may have a molar ratio of the oxygen element per mole of the silicon element being 0.8 to 1.2.

If the molar ratio of the oxygen element per mole of the silicon element in the mixture in step (1) is less than 0.8 or greater than 1.2, a large amount of reaction residues may remain after the second step reaction is carried out, which lowers the production yield.

Meanwhile, the average particle diameter of the silicon powder and the silicon dioxide powder used as the raw material is not limited, respectively. For example, the average particle diameter of the silicon powder may be 5 μm to 50 μm, 10 μm to 40 μm, or 15 μm to 30 μm, and the average particle diameter of the silicon dioxide powder may be 5 nm to 50 nm, 10 nm to 40 nm, or 15 nm to 30 nm.

If a powder having an average particle diameter within the above range is used, the deposition and evaporation of silicon dioxide become uniform, and fine silicon can be obtained.

In the process for preparing a silicon-based-carbon composite according to an embodiment of the present invention, step (2) may comprise heating and evaporating the mixture and metallic magnesium at different temperatures and depositing and cooling them to obtain a silicon-silicon composite oxide (composite A).

The heating and evaporation of the mixture in step (2) may be carried out at 900° C. to 1,800° C., 1,000° C. to 1,600° C., or 1,200° C. to 1,600° C. under a pressure of 0.0001 Torr to 2 Torr. If the temperature is lower than 900° C., it may be difficult for the reaction to be carried out, thereby lowering productivity. If it exceeds 1,800° C., the reactivity may be reduced.

In addition, the heating and evaporation of metallic magnesium in step (2) may be carried out at 500° C. to 1,100° C., 600° C. to 1,000° C., or 650° C. to 900° C. under a pressure of 0.0001 Torr to 2 Torr.

If the heating and evaporation of the mixture and the metallic magnesium satisfy the above ranges, fine silicon and fine magnesium silicate may be produced, whereby a silicon oxide compound having a desired SiOₓ (0.5≤x≤1.5) composition may be obtained.

Meanwhile, the deposition in step (2) may be carried out at 300° C. to 800° C., specifically, 400° C. to 700° C.

The cooling may be carried out by rapidly cooling to room temperature by water cooling. In addition, it may be carried out at room temperature while an inert gas is injected. The inert gas may be at least one selected from carbon dioxide gas, argon (Ar), helium (He), nitrogen (N₂), and hydrogen (H₂).

In the present invention, the mixture and metallic magnesium are heated and evaporated and then deposited on a substrate in a reactor to synthesize a silicon-silicon composite oxide through a uniform vapor-phase reaction of particles; thus, it is possible to prevent the rapid growth of silicon due to an exothermic reaction as magnesium is locally mixed in excess as in a solid-state reaction.

In the process for preparing a silicon-based-carbon composite according to an embodiment of the present invention, step (3) may comprise thermally treating the silicon-silicon composite oxide to obtain a thermally treated silicon-silicon composite oxide (composite B) as a core.

The thermal treatment may be carried out at 700° C. to 950° C. Specifically, the thermal treatment may be carried out at 800° C. to 950° C. or 900° C. to 930° C. for 1 to 10 hours or 1 to 5 hours.

In the process for preparing a silicon-based-carbon composite according to an embodiment of the present invention, step (4) may comprise carrying out pulverization and classification such that the average particle diameter of the thermally treated silicon-silicon composite oxide as a core is 3 μm to 15 μm to obtain a silicon-silicon composite oxide powder (composite C).

More specifically, the pulverization may be carried out such that the average particle diameter (D₅₀) of the thermally treated silicon-silicon composite oxide as a core is 3 μm to 10 μm, specifically, 3 μm to 8 μm.

For the pulverization, a pulverizing apparatus well known in the art may be used. For example, the pulverization may be carried out using at least one selected from the group consisting of a jet mill, a ball mill, a stirred media mill, a roll mill, a hammer mill, a pin mill, a disk mill, a colloid mill, and an atomizer mill.

Specifically, the pulverization may be carried out using a ball mill or a stirred media mill that moves a pulverizing medium, such as balls and beads, to pulverize the object to be pulverized by using an impact, friction, or compressive force supplied by the kinetic energy, or a roll mill that performs pulverization using a compressive force by a roller. In addition, a jet mill may be used, which causes the object to be pulverized to collide with the interior material or to collide with each other at a high speed, to perform pulverization by an impact force supplied by the collision. In addition, a hammer mill, a pin mill, or a disk mill may be used to pulverize the object to be pulverized using an impact force supplied by the rotation of a rotor provided with hammers, blades, or pins. In addition, a colloid mill using a shear force or an atomizer mill as a high-pressure wet opposing impact type disperser may be used.

In addition, the classification may be carried out using at least one selected from dry classification, wet classification, and sieve classification.

According to an embodiment of the present invention, a dry classification equipped with a cyclone together with a jet mill may be used.

In the jet mill, the processes of dispersion, separation (separation of fine particles and coarse particles), collection (separation of solids and gases), and discharge may be sequentially carried out using an air stream. In such a case, the classification efficiency should not be impaired by the impact of interference between particles, particle shape, disturbance of air stream, velocity distribution, and static electricity.

That is, the air stream to be used is pretreated (for adjustment of moisture, dispersibility, humidity, and the like) before classification to adjust the concentration of moisture and oxygen. In addition, in a dry type, such as a cyclone, in which a classifier is integrated, pulverization and classification are carried out at a time, making it possible to achieve a desired particle size distribution.

In the process for preparing a silicon-based-carbon composite according to an embodiment of the present invention, step (5) may comprise forming a first carbon layer on the surface of the silicon-silicon composite oxide powder.

In step (5), a first carbon layer is formed on the surface of the silicon-silicon composite oxide powder, and the first carbon layer may enhance the electrical contact between particles. In addition, since excellent electrical conductivity may be imparted even after the electrode is expanded by charging and discharging, the performance of the secondary battery can be further enhanced.

The first carbon layer may increase the conductivity of the negative electrode active material to enhance the output characteristics and cycle characteristics of the secondary battery and may increase the stress relaxation effect when the volume of the negative electrode active material is changed.

The formation of the first carbon layer may be carried out using one or more methods selected from a dry coating method and a liquid coating method.

Specifically, the formation of the first carbon layer may be carried out using a dry coating method. As an example of the dry coating method, a deposition method, specifically, a chemical vapor deposition (CVD) method may be used.

Since the first carbon layer is uniformly formed over the entire surface of the core (silicon-silicon composite oxide powder) through the chemical vapor deposition, a carbon film (first carbon layer) having high crystallinity can be formed. Thus, when the silicon-based-carbon composite is used as a negative electrode active material, the electrical conductivity of the negative electrode active material can be enhanced without changing the structure.

The step of forming a first carbon layer may be carried out by injecting at least one selected from compounds represented by the following Formulae 2 to 4 and carrying out a reaction of the silicon-silicon composite oxide powder obtained in step (4) in a gaseous state at 600° C. to 1,200° C.

C_{N}H_{(2N+2-A)}[OH]_{A} [Formula 2]

in Formula 2, N is an integer of 1 to 20, and A is 0 or 1,

C_{N}H_{(2N-B)} [Formula 3]

in Formula 3, N is an integer of 2 to 6, and B is 0 to 2,

CₓH_{y}O_{z} [Formula 4]

in Formula 4, x is an integer of 1 to 20, y is an integer of 0 to 25, and z is an integer of 0 to 5.

In addition, in Formula 4, x may be the same as, or smaller than, y.

The compound represented by Formula 2 may be at least one selected from the group consisting of methane, ethane, propane, butane, methanol, ethanol, propanol, propanediol, and butanediol. The compound represented by Formula 3 may be at least one selected from the group consisting of ethylene, propylene, butylene, butadiene, and cyclopentene. The compound represented by Formula 4 may be at least one selected from the group consisting of acetylene, benzene, toluene, xylene, ethylbenzene, naphthalene, anthracene, and dibutyl hydroxytoluene (BHT).

The carbon source gas may further comprise at least one inert gas selected from hydrogen, nitrogen, helium, and argon. In addition, at least one gas selected from water vapor, carbon monoxide, and carbon dioxide may be further added together with the carbon source gas.

When water vapor is added in the reaction, the silicon-based-carbon composite may have a higher conductivity.

According to an embodiment of the present invention, since a carbon layer with high crystallinity is formed on the surface of the silicon-based-carbon composite when water vapor is added in the reaction, high conductivity can be achieved even when a smaller amount of carbon is coated. The content of water vapor is not particularly limited. For example, it may be 0.01 to 10% by volume based on 100% by volume of the total carbon source gas.

The carbon source gas may be, for example, methane, a mixed gas containing methane and an inert gas, an oxygen-containing gas, or a mixed gas containing methane and an oxygen-containing gas.

According to an embodiment, the carbon source gas may be a mixed gas of CH₄ and CO₂ or a mixed gas of CH₄, CO₂, and H₂O.

The mixed gas of CH₄ and CO₂ may be provided at a molar ratio of about 1:0.20 to 0.50. Specifically, the mixed gas of CH₄ and CO₂ may have a molar ratio of 1:0.25 to 0.45. More specifically, it may have a molar ratio of about 1:0.30 to 0.40.

In addition, a mixed gas of CH₄, CO₂, and H₂O may have a molar ratio of about 1:0.20 to 0.50:0.01 to 1.45, specifically, 1:0.25 to 0.45:0.10 to 1.35, in particular, about 1:0.30 to 0.40:0.50 to 1.0.

According to another embodiment, the carbon source gas may be a mixed gas of CH₄ and N₂.

The mixed gas of CH₄ and N₂ may have a molar ratio of about 1:0.20 to 0.50, specifically, about 1:0.25 to 0.45, more specifically, 1:0.30 to 0.40.

In addition, according to an embodiment, the carbon source gas may not comprise an inert gas such as nitrogen.

The reaction may be carried out at 600° C. to 1,200° C., specifically, 700° C. to 1,100° C., more specifically, 700° C. to 1,000° C.

The pressure during the thermal treatment may be selected in consideration of the thermal treatment temperature, the composition of the gas mixture, the amount of carbon coating, and the like. The pressure during the thermal treatment may be controlled by adjusting the amount of the gas mixture introduced and the amount of the gas mixture discharged. For example, the pressure during the thermal treatment may be 0.1 atm or more, for example, 0.5 atm or more, 1 atm or more, 2 atm or more, 3 atm or more, or 5 atm or more, but it is not limited thereto.

The reaction time (or thermal treatment time) may be appropriately adjusted depending on the thermal treatment temperature, the pressure during the thermal treatment, the composition of the gas mixture, and the desired amount of carbon coating. For example, the reaction time may be 10 minutes to 100 hours, specifically, 30 minutes to 90 hours, more specifically, 50 minutes to 40 hours, but it is not limited thereto. Without being bound by a particular theory, as the reaction time is longer, the thickness of the carbon layer formed increases, which may enhance the electrical properties of the composite.

In the process for preparing a silicon-based-carbon composite according to an embodiment of the present invention, it is possible to form a first carbon layer, which is thin and uniform and comprises at least one selected from amorphous carbon, crystalline carbon, carbon nanofibers, reduced graphene oxide, and carbon nanotubes as a main component, on the surface of the silicon-silicon composite oxide even at a relatively low temperature through a gas-phase reaction of the carbon source gas. In addition, the detachment reaction in the first carbon layer thus formed does not substantially take place.

Meanwhile, as an example of the liquid coating method, one or more methods selected from an impregnation method and a spray drying method may be used.

For example, when amorphous carbon is used to form a first carbon layer, the core may be coated with a carbon precursor containing amorphous carbon by one or more methods selected from an impregnation method and a spray drying method, followed by thermal treatment thereof to form a first carbon layer.

More specifically, the core may be coated with a carbon precursor such as coal-based pitch, mesophase pitch, petroleum-based pitch, coal-based oil, petroleum-based heavy oil (intermediate crude oil), organic synthetic pitch, and polymer resins such as phenol resins, furan resins, and polyimide resins, followed by thermal treatment thereof to form a first carbon layer.

Meanwhile, when crystalline carbon is used to form a first carbon layer, a core material and crystalline carbon are mixed in a liquid phase, and a coating step may then be carried out. The crystalline carbon may be at least one selected from the group consisting of plate-shaped, spherical, and fibrous natural graphite and fibrous artificial graphite.

When the mixing is carried out in a liquid phase as described above, mechanical mixing, spray drying, spray pyrolysis, or freeze drying may be used as in the mixing in a solid phase. Water, an organic solvent, or a mixture thereof may be used as a solvent added in the liquid-phase mixing. Ethanol, isopropyl alcohol, toluene, benzene, hexane, tetrahydrofuran, or the like may be used as the organic solvent.

In addition, when carbon nanofibers or carbon nanotubes are used to form a first carbon layer, it may be carried out using a conventional method such as mechanical mixing or spray drying.

In addition, the structure of the graphene-containing material may be a layer or nanosheet type, or a structure in which several flakes are mixed.

If a first carbon layer is uniformly formed over the entire surface of the silicon-silicon composite oxide powder, it is possible to suppress volume expansion as a graphene-containing material that has enhanced conductivity and is flexible for volume expansion is directly grown on the surface of silicon, a silicon oxide compound, and magnesium silicate.

In addition, the coating of a first carbon layer may reduce the chance that silicon directly meets the electrolyte, thereby reducing the formation of a solid electrolyte interphase layer.

According to an embodiment of the present invention, the formation of a first carbon layer may be carried out using a dry coating method, specifically, a CVD method. If a CVD method is used to form a first carbon layer, the internal pores of silicon are uniformly coated, resulting in the advantages that the volume expansion of silicon during charging and discharging and the sintering of silicon caused by the volume expansion are suppressed.

According to an embodiment of the present invention, since the core of the silicon-based-carbon composite is immobilized by the first carbon layer, it is possible to suppress structural collapse due to the volume expansion of silicon, a silicon oxide compound, and magnesium silicate even if a binder is not used in the preparation of a negative electrode active material composition, and it can be advantageously used in the fabrication of an electrode and a lithium secondary battery having excellent electrical conductivity and capacity characteristics by minimizing an increase in resistance.

In the process for preparing a silicon-based-carbon composite according to an embodiment of the present invention, step (6) may comprise forming a second carbon layer on the surface of the first carbon layer to obtain a composite having a core-shell structure (composite D).

The second carbon layer may be formed using reduced graphene oxide. The reduced graphene oxide may be formed by partially or substantially completely reducing graphene oxide. Specifically, a second carbon layer may be formed from reduced graphene oxide on the surface of the first carbon layer through a partial x-n bond between carbon-carbon layers or a physical bond while it is dried by a spray dryer.

The formation of a second carbon layer may be carried out using one or more methods selected from a dry coating method and a liquid coating method as in the formation of the first carbon layer. Specifically, the formation of the second carbon layer may be carried out using a spray drying method among a liquid coating method. If a spray drying method is used to form a second carbon layer, it is possible to control the carbon content by adjusting the concentration of reduced graphene and to carrying out the coating at a low temperature unlike a chemical vapor method, resulting in the advantages that an increase in the crystal size of silicon caused during carbon coating by a chemical vapor method at a high temperature would not take place. In the formation of a second carbon layer, oxidized graphene or reduced graphene is dispersed in a solvent to prepare a dispersion, in which the concentration of the dispersion is 0.01 to 50 mg/ml. In the preparation process of the present invention, the temperature in the spray drying is 100 to 250° C.

According to an embodiment of the present invention, the first carbon layer may be formed using a CVD method, and the second carbon layer may be formed using a spray drying method.

The process for preparing a silicon-based-carbon composite according to an embodiment of the present invention may further comprise carrying out at least one of pulverization and classification of the composite having a core-shell structure obtained in step (6) (step (7)).

According to an embodiment of the present invention, as the composite having a core-shell structure is subjected to pulverization and/or classification, a silicon-based-carbon composite having a particle size desired in the present invention can be obtained.

Specifically, in step (7), the composite having a core-shell structure obtained in step (6) may be classified. Alternatively, the composite having a core-shell structure may be pulverized. Alternatively, the composite having a core-shell structure may be pulverized and classified. Specifically, the composite having a core-shell structure obtained in step (6) may be classified and, if necessary, pulverized.

The pulverization and classification may be used in the same manner as the pulverization and classification used in step (4).

In addition, the silicon-based-carbon composite may be pulverized and/or classified to have an average particle diameter of 3 μm to 15 μm, specifically, 3 μm to 10 μm or 3 μm to 8 μm, more specifically, 3 μm to 7 μm.

Meanwhile, the process for preparing a silicon-based-carbon composite according to another embodiment of the present invention may comprise (1′) preparing a mixture obtained by using a silicon powder and a silicon dioxide powder; (2′) heating and evaporating the mixture and metallic magnesium at different temperatures and depositing and cooling them to obtain a silicon-silicon composite oxide; (3′) thermally treating the silicon-silicon composite oxide to obtain a thermally treated silicon-silicon composite oxide as a core; (4′) carrying out pulverization and classification such that the average particle diameter of the thermally treated silicon-silicon composite oxide as a core is 3 μm to 15 μm to obtain a silicon-silicon composite oxide powder; (5′) forming a second carbon layer on the surface of the silicon-silicon composite oxide powder; and (6′) forming a first carbon layer on the surface of the second carbon layer to obtain a composite having a core-shell structure.

Steps (1′) to (4′) may be carried out under the conditions identical or similar to those of steps (1) to (4) described above.

In addition, the method of forming a second carbon layer in step (5′) may be carried out under the conditions identical or similar to those of the method of forming a second carbon layer in step (6).

In addition, the method of forming a first carbon layer in step (6′) may be carried out under the conditions identical or similar to those of the method of forming a first carbon layer in step (5).

Meanwhile, the process for preparing a silicon-based-carbon composite according to an embodiment of the present invention may further comprise carrying out at least one of pulverization and classification of the composite having a core-shell structure obtained in step (6′) (step (7′)).

The pulverization and classification may be used in the same manner as the pulverization and classification used in step (4).

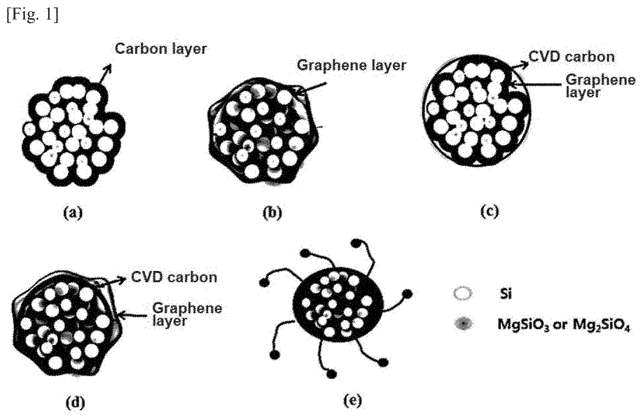

FIG. 1 shows various schematic diagrams of a silicon-based-carbon composite comprising two carbon layers according to an embodiment of the present invention.

In FIG. 1, (a) is a schematic diagram in which a silicon-silicon composite oxide as a core is primarily coated (CVD), (b) is a schematic diagram in which a silicon-silicon composite oxide as a core is primarily coated (graphene layer) by a wet process, and (c) to (e) are various schematic diagrams of a silicon-based-carbon composite in which a first carbon layer and a second carbon layer are formed from various materials on a silicon-silicon composite oxide according to various embodiments of the present invention.

Physical Properties of a Silicon-Based-Carbon Composite

The silicon-based-carbon composite according to an embodiment of the present invention may have an average particle diameter of 3 μm to 15 μm, 3 μm to 10 μm, or 3 μm to 8 μm.

If the average particle diameter of the silicon-based-carbon composite is within the above range, it is easy to occlude and release lithium ions during charging and discharging, thereby reducing particle breakage. If the average particle diameter of the silicon-based-carbon composite is 3 μm or more, the surface area per unit weight may be reduced, and an increase in the irreversible capacity of a secondary battery may be suppressed. In addition, the specific surface area can be made sufficiently small, thereby avoiding any adverse impact by the specific surface area that would become too large. In addition, if the average particle diameter of the silicon-based-carbon composite is 15 μm or less, the negative electrode active material is readily applied in the preparation of a negative electrode, which may be advantageous in terms of the process. In addition, if the average particle diameter is controlled within the above range, when the silicon-based-carbon composite is used as a negative electrode active material, uniform contraction and expansion can be secured, thereby enhancing the cycle characteristics and initial efficiency of the secondary battery.

If the average particle diameter of the silicon-based-carbon composite exceeds 15 μm, the expansion of the composite particles due to the charging of lithium ions becomes severe, and the binding capability between the particles of the composite and the binding capability between the particles and the current collector are deteriorated as charging and discharging are repeated, so that the lifespan characteristics may be significantly reduced. In addition, there is a concern that the activity may be deteriorated due to a significant decrease in the specific surface area.

If the average particle diameter of the silicon-based-carbon composite is less than 3 μm, there is a concern that the dispersibility may be deteriorated due to the aggregation of particles of the composite during the preparation of a negative electrode active material composition using the same.

The silicon-based-carbon composite may have a specific gravity of 1.8 g/cm³ to 2.6 g/cm³, specifically, 1.8 g/cm; to 2.5 g/cm³ or 1.8 g/cm³ to 2.4 g/cm³.

The silicon-based-carbon composite may have a specific gravity of 1.8 g/cm³ to 2.6 g/cm³ and a specific surface area (Brunauer-Emmett-Teller; BET) of 1 m²/g to 40 m²/g.

Specific gravity may refer to true specific gravity, density, or true density.

According to an embodiment of the present invention, for the measurement of specific gravity, for example, for the measurement of specific gravity by a dry density meter, Acupick II 1340 manufactured by Shimadzu Corporation may be used as a dry density meter. The purge gas to be used may be helium gas, and the measurement may be carried out after 200 times of purge in a sample holder set at a temperature of 23° C.

If the specific gravity of the silicon-based-carbon composite is 1.8 g/cm³ or more, the dissociation between the negative electrode active material powder due to the volume expansion of the negative electrode active material during charging may be prevented, and the cycle deterioration may be suppressed. If the specific gravity is 2.6 g/cm³ or less, the impregnability of an electrolyte is enhanced, which increases the utilization rate of the negative electrode active material, so that the initial charge and discharge capacity can be enhanced.

In contrast, if the specific gravity of the silicon-based-carbon composite is less than 1.8 g/cm³, the rate characteristics of the secondary battery may be deteriorated. If it exceeds 2.6 g/cm³, the contact area with the electrolyte increases, which may expedite the decomposition reaction of the electrolyte, or a side reaction of the battery may take place.

In addition, the silicon-based-carbon composite may have a specific surface area of 3 m²/g to 50 m²/g, 3 m²/g to 30 m²/g, or 3 m²/g to 10 m²/g. If the specific surface area of the silicon-based-carbon composite is less than 3 m²/g, the surface activity is low, and the bonding force of the binder in the preparation of an electrode is weak. As a result, the cycle characteristics may be decreased when charging and discharging are repeated. On the other hand, if the specific surface area of the silicon-based-carbon composite exceeds 50 m²/g, the amount of a solvent absorbed in the preparation of an electrode is increased, which may require a large amount of a binder in order to maintain binding properties. As a result, there is a concern that the conductivity may be lowered, resulting in deteriorated cycle characteristics. Further, the contact area with the electrolyte increases, which may expedite the decomposition reaction of the electrolyte, or a side reaction of the battery may take place.

The specific surface area can be measured by the BET method by nitrogen adsorption. For example, a specific surface area measuring device (Macsorb HM (model 1210) of MOUNTECH, Belsorp-mini±of Microtrac BEL, or the like) generally used in the art may be used.

The silicon-based-carbon composite may have an electrical conductivity of 100 S/cm to 3,000 S/cm, specifically, 500 S/cm to 3,000 S/cm, more specifically, 1,000 S/cm to 3,000 S/cm. The electrical conductivity of a negative electrode active material is an important factor for facilitating electron transfer during an electrochemical reaction. However, when a high-capacity negative electrode active material is prepared using silicon or a silicon oxide compound, it is not easy to achieve an appropriate level of electrical conductivity.

Thus, an embodiment of the present invention can provide a negative electrode active material having an electrical conductivity satisfying the above range by preparing the silicon-based-carbon composite, which has a core-shell structure comprising a shell comprising at least two carbon layers on the surface of a core comprising silicon, a silicon oxide compound, and magnesium silicate. In particular, it is possible to enhance the charge and discharge capacity, initial charge and discharge efficiency, and capacity retention rate of a secondary battery.

Negative Electrode Active Material

The negative electrode active material according to an embodiment may comprise the silicon-based-carbon composite. Specifically, the silicon-based-carbon composite employed in the negative electrode active material has a core-shell structure, wherein the core comprises silicon, a silicon oxide compound, and magnesium silicate, and the shell comprises at least two carbon layers comprising a first carbon layer and a second carbon layer, wherein the second carbon layer may be reduced graphene oxide.

In addition, the negative electrode active material may further comprise a carbon-based negative electrode material.

The negative electrode active material may be used as a mixture of the silicon-based-carbon composite and the carbon-based negative electrode material. In such an event, the electrical resistance of the negative electrode active material can be reduced, while the expansion stress involved in charging can be relieved at the same time. The carbon-based negative electrode material may comprise, for example, at least one selected from the group consisting of natural graphite, synthetic graphite, soft carbon, hard carbon, mesocarbon, carbon fibers, carbon nanotubes, pyrolytic carbon, coke, glass carbon fibers, sintered organic high molecular compounds, and carbon black. Specifically, the negative electrode active material may further comprise a graphite-based negative electrode material as a carbon-based negative electrode material.

The carbon-based negative electrode material, for example, a graphite-based negative electrode material may be employed in an amount of 30% by weight to 80% by weight, specifically, 30% by weight to 60% by weight, more specifically, 30% by weight to 50% by weight, based on the total weight of the negative electrode active material.

Secondary Battery

The present invention may provide a negative electrode comprising the negative electrode active material and a secondary battery comprising the same.

The secondary battery may comprise a positive electrode, a negative electrode, a separator interposed between the positive electrode and the negative electrode, and a non-aqueous liquid electrolyte in which a lithium salt is dissolved. The negative electrode active material may comprise a negative electrode active material comprising a silicon-based-carbon composite.

The negative electrode may be composed of a negative electrode composition only or may be composed of a negative electrode current collector and a negative electrode composition layer (negative electrode active material layer) supported thereon. Similarly, the positive electrode may be composed of a positive electrode composition only or may be composed of a positive electrode current collector and a positive electrode composition layer (positive electrode active material layer) supported thereon. In addition, the negative electrode composition and the positive electrode composition may each further comprise a conductive agent and a binder.

Materials known in the art may be used as a material constituting the negative electrode current collector and a material constituting the positive electrode current collector. Materials known in the art may be used as a binder and a conductive material added to the negative electrode and the positive electrode.

If the negative electrode is composed of a current collector and an active material layer supported thereon, the negative electrode may be prepared by coating the negative electrode active material composition comprising the silicon-based-carbon composite on the surface of the current collector and drying it.

In addition, the secondary battery comprises a non-aqueous liquid electrolyte in which the non-aqueous liquid electrolyte may comprise a non-aqueous solvent and a lithium salt dissolved in the non-aqueous solvent. A solvent commonly used in the field may be used as a non-aqueous solvent. Specifically, an aprotic organic solvent may be used.

Examples of the aprotic organic solvent include cyclic carbonates such as ethylene carbonate, propylene carbonate, and butylene carbonate, cyclic carboxylic acid esters such as furanone, chain carbonates such as diethyl carbonate, ethylmethyl carbonate, and dimethyl carbonate, chain ethers such as 1,2-methoxyethane, 1,2-ethoxyethane, and ethoxymethoxyethane, and cyclic ethers such as tetrahydrofuran and 2-methyltetrahydrofuran. They may be used alone or in combination of two or more.

The secondary battery may comprise a non-aqueous secondary battery.

The negative electrode active material and the secondary battery using the silicon-based-carbon composite may enhance the capacity, initial charge and discharge efficiency, and capacity retention rate thereof.

### MODE FOR THE INVENTION

### Example

### Example 1

Preparation of a Silicon-Based-Carbon Composite

Step (1): Preparing a Mixture Obtained by Using a Silicon Powder and a Silicon Dioxide Powder

11 kg of a silicon powder having an average particle diameter of 20 μm and 15 kg of a silicon dioxide powder having an average particle diameter of 20 nm were added to 60 kg of water, stirred with a PL mixer for 12 hours for homogeneous mixing thereof, and then dried at 250° C. for 20 hours under a nitrogen atmosphere. Thereafter, the resultant was dried again at 600° C. for 12 hours to obtain a mixture.

Step (2): Heating and Evaporating the Mixture and Metallic Magnesium at Different Temperatures and Depositing and Cooling them to Obtain a Silicon-Silicon Composite Oxide

The mixture and 3 kg of metallic magnesium were put into crucible-A and crucible-B in a vacuum reactor, respectively. After the pressure was lowered to reach 0.01 Torr, the temperature of crucible-A was raised to 1,400° C., and the temperature of crucible-B was raised to 700° C., followed by a reaction for 5 hours and deposition on a deposition substrate in the reactor. The deposited substrate was rapidly cooled to room temperature by water cooling to obtain a silicon-silicon composite oxide (composite A1) as a core.

Step (3): Thermally Treating the Silicon-Silicon Composite Oxide to Obtain a Thermally Treated Silicon-Silicon Composite Oxide as a Core

The silicon-silicon composite oxide was thermally treated at 700° C. to 950° C. for 1 hour to obtain a thermally treated silicon-silicon composite oxide (composite B1) as a core.

Step (4): Carrying Out Pulverization and Classification of the Thermally Treated Silicon-Silicon Composite Oxide as a Core to Obtain a Silicon-Silicon Composite Oxide Powder

The thermally treated silicon-silicon composite oxide (composite B1) was pulverized once in a jet mill (Nets) under the conditions of an air pressure of 7.5 bar, a classifier rotation speed of 1,300 rpm, and a feeder speed of 216 rpm and recovered with a cyclone. A silicon-silicon composite oxide powder (composite C1) having an average particle diameter of 6.0 μm was obtained as a recovered pulverized product.

Step (5): Forming a First Carbon Layer on the Surface of the Silicon-Silicon Composite Oxide Powder

The silicon-silicon composite oxide powder (composite C1) was placed in an electric furnace. The pressure was reduced to 0.2 Torr with a rotary vacuum pump. Then, argon gas flowed at a flow rate of 0.3 liter/minute to reach normal pressure. Upon reaching normal pressure, the temperature in the electric furnace was raised to 1,000° C. at a rate of 200° C./hr. Upon reaching 1,000° C., carbon coating treatment was carried out for 10 hours while methane gas was injected into the electric furnace at a flow rate of 0.3 liter/minute. After the supply of methane gas was stopped, the inside of the electric furnace was cooled to room temperature to form a first carbon layer having a carbon (C) content of 3% by weight and a thickness of 30 nm.

Step (6): Forming a Second Carbon Layer on the Surface of the First Carbon Layer to Obtain a Composite Having a Core-Shell Structure

Reduced graphene was spray-dried (spray dryer method) on the surface of the first carbon layer to form a second carbon layer having a thickness of 48 nm on the surface of the first carbon layer, thereby obtaining a composite having a core-shell structure (composite D1).

In the preparation of wrinkled reduced graphene using a spray dryer, the silicon composite oxide having a first carbon layer obtained in step (5) at the same weight ratio was added and dispersed to reduced graphene (dispersed aqueous solution of 0.5% by weight). The dispersion was supplied at 100 ml/minute using a metering pump, and the preparation was carried out under the conditions of a speed of rotation of the spray dryer (16,000 rpm), a dispersion temperature of 220° C., and a chamber temperature of 140 to 150° C. Agglomerates of silicon oxide having a graphene layer or a first carbon layer, or a heavy composite coated with a thick graphene layer, fell directly into the collecting bin due to a high specific gravity, and the desired composite oxide with a coating layer was collected through a bag filter. For sufficient drying, it was further dried in a dryer at 120° C.

Step (7): Carrying Out at Least One Step of Pulverization and Classification of the Composite of a Core-Shell Structure

The composite of a core-shell structure was passed through a vibrating filter equipped with a 420-mesh sieve to obtain a final silicon-based-carbon composite (composite E1) having an average particle diameter of 5 to 7 μm.

Fabrication of a Secondary Battery

A negative electrode and a battery (coin cell) comprising the silicon-based-carbon composite (composite E1) of a core-shell structure as a negative electrode active material were fabricated.

The negative electrode active material, Super-P as a conductive material, and polyacrylic acid were mixed at a weight ratio of 80:10:10 with water to prepare a negative electrode active material composition having a solids content of 45%.

The negative electrode active material composition was applied to a copper foil having a thickness of 18 μm and dried to prepare an electrode having a thickness of 70 μm. The copper foil coated with the electrode was punched in a circular shape having a diameter of 14 mm to prepare a negative electrode plate for a coin cell.

Meanwhile, a metallic lithium foil having a thickness of 0.3 mm was used as a positive electrode plate.

A porous polyethylene sheet having a thickness of 25 μm was used as a separator. A liquid electrolyte in which LiPF₆ had been dissolved at a concentration of 1 M in a mixed solvent of ethylene carbonate (EC) and diethylene carbonate (DEC) at a volume ratio of 1:1 was used as an electrolyte. The above components were employed to fabricate a coin cell (battery) having a thickness of 3.2 mm and a diameter of 20 mm.

### Example 2

After step (5) of Example 1 was carried out, 0.5% by weight of graphene oxide was dispersed in an aqueous solution. The carbon-silicon composite of step (4) in the same amount was mixed with 0.5% by weight of FeSO₄·7H₂O and 0.1% by weight of CoSO₄·7H₂O, as a metal catalyst precursor, which was used to obtain a mixture of a first carbon layer-a second carbon layer-silicon and a metal catalyst using the spray-drying conditions of Example 1. This powder was further dried secondarily at 150° C. The mixture obtained by spray-drying was charged into a quartz tube and subjected to thermal treatment at 25° C. for 3 hours in an argon gas atmosphere (500 sccm). The temperature was raised to 950° C. at 22.5° C./minute in a methane gas atmosphere (500 sccm), and it was thermally treated at 950° C. for 90 minutes. A final silicon-carbon composite (composite E2) was obtained, which was used to fabricate a coin cell.

### Example 3

A silicon-based-carbon composite (composite E3) was prepared and a secondary battery using the same was fabricated in the same manner as in Example 1, except that the lamination sequence was reversed in steps (5) and (6) of Example 1.

### Example 4

A silicon-based-carbon composite (composite E4) was prepared and a secondary battery using the same was fabricated in the same manner as in Example 2, except that the lamination sequence was reversed in steps (5) and (6) of Example 2.

### Comparative Example 1

A silicon-based-carbon composite was prepared and a secondary battery using the same was fabricated in the same manner as in Example 1, except that step (6) of Example 1 was not carried out.

### Comparative Example 2

A silicon-based-carbon composite was prepared and a secondary battery using the same was fabricated in the same manner as in Example 3, except that step (5) of Example 3 was not carried out.

### Comparative Example 3

A silicon-based-carbon composite was prepared and a secondary battery using the same was fabricated in the same manner as in Example 4, except that step (6) of Example 4 was not carried out.

### Comparative Example 4

A CNT powder commercially available was physically adsorbed to a silicon core powder using Mechano fusion equipment without carrying out steps (5) and (6) of Example 1, thereby preparing a silicon-based-carbon composite and a secondary battery.

TABLE 1

| | | Example | | | | Comparative Example | | | |
|---|---|---|---|---|---|---|---|---|---|
| | | 1 | 2 | 3 | 4 | 1 | 2 | 3 | 4 |
| First | Type | CVD | CVD | Reduced | Reduced | CVD | Reduced | Reduced | CNT |
| carbon | | (methane) | (methane) | graphene | graphene- | (methane) | graphene | graphene- | |
| layer | | coating | coating | coating | CNT | coating | coating | CNT | |
| | C content | 3 | 3 | 7 | 10 | 5.6 | 7 | 10 | 6 |
| | (wt. %) | | | | | | | | |
| | Thickness | 30 | 27 | 80 | 100 | 30 | 80 | 100 | 24 |
| | (nm) | | | | | | | | |
| | Lamination | Core surface/ | Core surface/ | Core surface | Core stirface | Core/ | Core | Core | |
| | position | internal pores | internal pores | | | internal | surface | surface | |
| | | | | | | surface | | | |
| Second | Type | Reduced | Reduced | CVD | CVD | — | | | |
| carbon | | graphene | graphene- | (methane) | (methane) | | | | |
| layer | | coating | CNT | coating | coating | | | | |
| | C content (wt. %) | 5.9 | 5 | 2 | 5 | | | | |
| | 0 content (wt. %) | 30.1 | 2 | 7 | 5 | | | | |
| | Thickness (nm) | 48 | 51 | 62 | 45 | | | | |
| | Lamination | First carbon | First carbon | First carbon | First carbon | | | | |
| | position | layer surface | layer surface | layer surface/ | layer surface/ | | | | |
| | | | | core surface | core surface | | | | |
| | Li, Na, K (wt. %) | 4 | 3 | 4 | 4 | | | | |
| | BET (m²/g) | 7.8 | 8 | 3 | 4 | | | | |
| | Electric | 2,700 | 2,900 | 1,300 | 900 | | | | |
| | Conductivity | | | | | | | | |
| | (S/cm) | | | | | | | | |
| | Electrode | 62 | 74 | 82 | 76 | 128 | 94 | 110 | 162 |
| | expansion (%) | | | | | | | | |

| | | | | | | | | |
|---|---|---|---|---|---|---|---|---|
| Total carbon content (wt. %) | 5.9 | 8 | 9 | 15 | 5.6 | 7 | 10 | 6 |
| Total no. of lamination/ | 2 | 3 | 2 | 3 | 1 | 1 | 1 | 1 |
| Total thickness | | | | | | | | |
| BET (m²/g) | 7.8 | 8 | 3 | 4 | 6.3 | 14 | 22 | 52 |
| True specific gravity (g/cc) | 2.2 | 2.1 | 2.3 | 2.2 | 2.2 | 2.3 | 2.3 | 2.2 |
| Electric Conductivity (S/cm) | 2.700 | 2,900 | 1,300 | 900 | 400 | 1,100 | 900 | 450 |
| Initial charge & discharge | 81.3 | 79.2 | 78.1 | 76.3 | 82 | 74 | 72 | 68 |
| efficiency (%) | | | | | | | | |
| Charge & discharge capacity | 1,374 | 1,287 | 1,410 | 1,380 | 1,362 | 1,290 | 1,310 | 1,210 |
| (mAh/g) | | | | | | | | |
| Capacity retention rate | 89.9 | 84 | 81 | 82 | 74 | 72 | 68 | 65 |
| upon 100 cycles (%) | | | | | | | | |

### INDUSTRIAL APPLICABILITY

The silicon-based-carbon composite according to an embodiment of the present invention has a core-shell structure. In particular, it is characterized in that the shell comprises at least two carbon layers comprising a first carbon layer and a second carbon layer and that the second carbon layer is reduced graphene oxide; thus, when it is applied as a negative electrode active material for a secondary battery, it is possible to enhance the charge and discharge capacity, initial charge and discharge efficiency, and capacity retention rate of the secondary battery at the same time. Therefore, the silicon-based-carbon composite can be advantageously used in the preparation of a negative electrode active material for a lithium secondary battery.

1. A silicon-based-carbon composite having a core-shell structure, wherein the core comprises silicon, a silicon oxide compound, and magnesium silicate, and the shell comprises at least two carbon layers comprising a first carbon layer and a second carbon layer, wherein the second carbon layer is reduced graphene oxide.

2. The silicon-based-carbon composite of claim 1, wherein the first carbon layer comprises at least one selected from the group consisting of amorphous carbon, crystalline carbon, carbon nanofibers, chemical vapor graphene, and carbon nanotubes.

3. The silicon-based-carbon composite of claim 1, wherein the first carbon layer and the second carbon layer are sequentially disposed on the core, or the second carbon layer and the first carbon layer are sequentially disposed on the core.

4. The silicon-based-carbon composite of claim 1, wherein the first carbon layer and the second carbon layer have a thickness of 2 nm to 400 nm and 20 nm to 1 μm, respectively.

5. The silicon-based-carbon composite of claim 1, wherein the total content of carbon (C) in the first carbon layer and the second carbon layer is 5% by weight to 50% by weight based on the total weight of the silicon-based-carbon composite.

6. The silicon-based-carbon composite of claim 5, wherein the content of carbon (C) in the first carbon layer is 2% by weight to 30% by weight based on the total weight of the silicon-based-carbon composite, and the content of carbon (C) in the second carbon layer is 3% by weight to 20% by weight based on the total weight of the silicon-based-carbon composite.

7. (canceled)

8. The silicon-based-carbon composite of claim 1, wherein the content of oxygen (O) in the reduced graphene oxide in the second carbon layer is 0.01% by weight to 20% by weight based on the total weight of the reduced graphene oxide.

9. The silicon-based-carbon composite of claim 1, wherein the reduced graphene oxide in the second carbon layer comprises at least one selected from the group consisting of lithium (Li), sodium (Na), and potassium (K) in an amount of 0.02% by weight to 5% by weight based on the total weight of carbon (C) in the second carbon layer.

10. The silicon-based-carbon composite of claim 1, wherein the second carbon layer has a specific surface area (Brunauer-Emmett-Teller; BET) of 5 m²/g to 30 m²/g and an electrical conductivity of 100 S/cm to 3,000 S/cm.

11. (canceled)

12. The silicon-based-carbon composite of claim 1, wherein the reduced graphene oxide of the second carbon layer has I_{1,360}/I_{1,580} of 0.1 to 2, which is an integrated intensity ratio for absorption bands of 1,360 cm⁻¹ and 1,580 cm⁻¹.

13. (canceled)

14. (canceled)

15. The silicon-based-carbon composite of claim 1, wherein the magnesium silicate comprises at least one selected from MgSiO₃ crystals and Mg₂SiO₄ crystals.

16. The silicon-based-carbon composite of claim 15, wherein, in an X-ray diffraction analysis of the magnesium silicate, the ratio IF/IE of an intensity (IF) of the X-ray diffraction peak corresponding to Mg₂SiO₄ crystals appearing in the range of 2θ=22.3° to 23.3° to an intensity (IE) of the X-ray diffraction peak corresponding to MgSiO₃ crystals appearing in the range of 2θ=30.5° to 31.5° is greater than 0 to 1.

17. (canceled)

18. (canceled)

19. (canceled)

20. A process for preparing the silicon-based-carbon composite of claim 1, which comprises:
obtaining a silicon-silicon composite oxide as a core;
carrying out pulverization and classification such that the average particle diameter of the silicon-silicon composite oxide as a core is 3 μm to 15 μm to obtain a silicon-silicon composite oxide powder;
forming a first carbon layer on the surface of the silicon-silicon composite oxide powder; and
forming a second carbon layer on the surface of the first carbon layer to obtain a composite having a core-shell structure.

21. A process for preparing the silicon-based-carbon composite of claim 1, which comprises:
obtaining a silicon-silicon composite oxide as a core;
carrying out pulverization and classification such that the average particle diameter of the silicon-silicon composite oxide as a core is 3 μm to 15 μm to obtain a silicon-silicon composite oxide powder;
forming a second carbon layer on the surface of the silicon-silicon composite oxide powder; and
forming a first carbon layer on the surface of the second carbon layer to obtain a composite having a core-shell structure.

22. (canceled)

23. The process for preparing the silicon-based-carbon composite according to claim 20, wherein the formation of the first carbon layer and the second carbon layer is carried out using one or more methods selected from a dry coating method and a liquid coating method.

24. The process for preparing the silicon-based-carbon composite according to claim 23, wherein the first carbon layer is formed using a chemical vapor deposition method, and the second carbon layer is formed using a spray drying method.

25. The process for preparing the silicon-based-carbon composite according to claim 24, wherein the formation of the first carbon layer is carried out by injecting at least one selected from compounds represented by the following Formulae 2 to 4 and carrying out a reaction in a gaseous state at 600° C. to 1,200° C.:
C_{N}H_{(2N+2-A)}[OH]_{A} [Formula 2]
in Formula 2, N is an integer of 1 to 20, and A is 0 or 1,
C_{N}H_{(2N-B)} [Formula 3]
in Formula 3, N is an integer of 2 to 6, and B is 0 to 2,
CₓH_{y}O_{z} [Formula 4]
in Formula 4, x is an integer of 1 to 20, y is an integer of 0 to 25, and z is an integer of 0 to 5.

26. The process for preparing the silicon-based-carbon composite according to claim 16, wherein the formation of the second carbon layer is carried out by spray drying under the conditions of a concentration of the dispersion of 0.01 to 50 mg/ml and a temperature of 100 to 250° C.

27. A negative electrode active material, which comprises the silicon-based-carbon composite of claim 1.

28. (canceled)

29. (canceled)

30. A lithium secondary battery, which comprises the negative electrode active material of claim 27.
